(19) United States
(12) Patent Application Publication
(10) Pub. No.: US 2008/0270156 A1
(43) Pub. Date: Oct. 30, 2008

(54) System and method for information technology service strategy

(76) Inventor: Tony Harrell, Charlestown, WV (US)

Correspondence Address: MAIER & MAIER, PLLC, 1000 DUKE STREET, ALEXANDRIA, VA, 22314, US

(21) Appl. No.: 11/790,753

(22) Filed: Apr. 27, 2007

(51) Int. Cl. G06F 15/16; G06Q 99/00

(52) U.S. Cl. 705/1; 709/218

(57) ABSTRACT

A method and system for providing information technology services. The method and system can include an information technology service provider and a client located remotely from the information technology service provider who may need information technology services. The service provider and the client may establish an amount of service to be provided. The service provider and the client may then also establish a data connection so as to allow for the access and exchange of data to and from each party. Thus the service provider may provide information technology service to the client and the client may access the information technology resources of the service provider from remote locations and the client may not need to maintain and information technology staff.

### FIELD OF THE INVENTION

This invention relates generally to the field of information technology services and, more particularly, to the field of providing information technology services to a remotely located client.

### BACKGROUND

Information technology services are almost universally utilized in present day businesses. The proliferation of computers and networking has increased the speed of business while allowing for the transfer and presentation of information and data. Educating users, acquiring, maintaining and upgrading components and remedying problems are needs of any modern business.

Presently, however, many businesses are either incapable of having and maintaining information technology (IT) personnel or do not have a consistent need for IT personnel. These businesses still experience IT problems and have IT needs, so they typically employ an ad-hoc IT solution that usually consists of various vendors and services that are not managed with any IT policy or procedure. These solutions do not have standardized computing and network infrastructures. Additionally computer and network management is not part of any ongoing solution. Therefore, over time, many businesses spend a significant amount of time, money and energy in attempts to provide information access, sharing and various business reporting.

Other businesses, during setup and development stages, resort to hiring an IT consultant or consulting firm. The IT consultant typically performs a requirements study and a site survey, purchases hardware and software and performs a facilities build out, instituting proper power delivery and climate control, for example. After this initial configuration and setup, the business utilizing the consultant often needs to hire one or more full time IT employees to perform day-to-day administration, management and monitoring of the business's IT. The cost of the IT consultant and/or one or more full time IT employees, however, is significant and can be prohibitive to many businesses.

### SUMMARY

An exemplary embodiment of the invention includes a system for providing IT services. The system can include a data center and at least one client located remotely from the data center and in need information technology service. The system may also have at least one data connection between the data center and the client. Additionally, in the system, the data center may provide information technology service to the client through the use of the data connection.

Another exemplary embodiment may include a method for providing information technology service. The method may begin by contacting an information technology service provider and then determining, through a consultation between the information technology service provider and a client, the amount of information technology service the client needs. In addition, the method may incorporate building an infrastructure to provide the amount of information technology service the client needs as well as providing information technology service to the client by the information technology service provider from a remote location.

In yet another exemplary embodiment, another system for providing information technology-related services to a remotely located client may be described. This system may include means for connecting a remotely located client to an information technology service provider and means for securing the connection between the remotely located client and the information technology service provider. The system may also contain means for the remotely located client to access data stored at the location of the information technology service provider. In further exemplary embodiments, the system may have means for the information technology service provider to provide information technology service and support to the remotely located client as well as means for providing on-site information technology service by the information technology service provider to the remotely located client.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram of an IT support and service provider connected to two clients.

FIG. 2 is an exemplary diagram of an IT support and service provider and the services provided to multiple clients.

FIG. 3 is an exemplary flow chart demonstrating a client establishing IT support and services.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments,” “embodiments of the invention,” “exemplary embodiments” and similar terms do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter.

Additionally, some exemplary embodiments include network adapters that may also be coupled to the system to enable the data processing system to become coupled to other data processing systems or, for example, remote printers or storage devices through intervening private or public networks. Modems, cable modems and Ethernet cards are just a few of the currently available types of network adapters.

Also, exemplary embodiments may include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

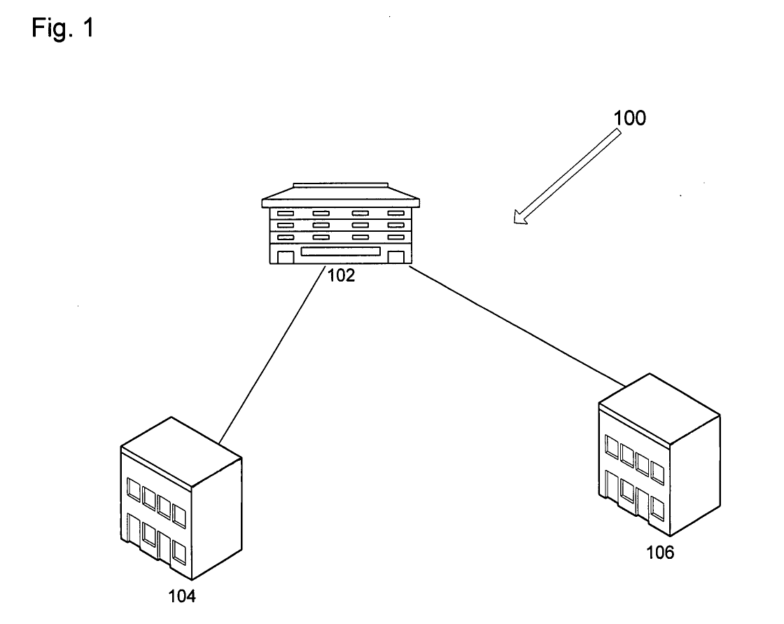

Generally referring to FIGS. 1-3, a method and system for providing IT support and services are disclosed. The method and system can include a centrally located data center, one or more service users and one or more mobile consultants. For example, a centrally located data center may provide IT services to a plurality of remotely located service users, who may be any size, for example, a small or large company. The IT services provided from the data center may be administered through an existing communication and data transfer infrastructure. Additionally, a data center may dispatch one or more consultants from one or more remote locations to administer IT services in the event that the services can not be administered through a communication infrastructure or data transfer connection.

In one embodiment, as shown in exemplary FIG. 1, a centralized data center may provide IT service and support to any number of clients. IT support system 100 may include data center 102. Data center 102 may be, for example, an office in a centralized location. Data center 102 may include any of a variety of IT capabilities and may be able to provide IT services and support to a remotely located client, for example clients 104 and 106, and any number of other clients who are not pictured. For example, in some exemplary embodiments, data center 102 may be able to provide such services as internet access and internet content filtering. In further exemplary embodiments, data center 102 may be responsible for designing, maintaining and hosting a web site for any number of clients, providing corporate email using a business domain or registered corporate entity. Data center 102 may also provide safeguards against hacking or any other unauthorized access to any of a client's data or online presences, as well as provide intrusion detection in the event of an attempted unauthorized access. Data center 102 may further provide for virus detection and prevention and spam prevention. Further, data center 102 can provide a centrally managed IT user policy with user authentication as well as other tools, such as system backups and disaster recovery services. In still further exemplary embodiments, data center 102 can provide for automated time and attendance reporting services, financial processing and reporting services and IT mobility services, such as supporting personal digital assistants (PDAs), notebook computers, and remote access capabilities. Additionally, data center 102 may provide any other IT service or support known to one having ordinary skill in the art.

As shown in exemplary FIG. 1, data center 102 may be connected to clients 104 and 106. Clients 104 and 106 may be located in any location, for example locations remote from data center 102. Additionally, data center 102 may be connected to remote client 104 or remote client 106 in any of a variety of manners. For example, data center 102 could be connected to remote client 104 through the use of a private network between data center 102 and remote client 104. Data center 102 could also be connected to remote client 106 through a standard Internet connection. Additionally, any other connection known to one having ordinary skill in the art may be used to connect data center 102 with any number of remote clients. Also, regardless of the number of remote clients and regardless of the type of connection or connections used to connect data center 102 with the one or more remote clients, one client may not have access to the information or resources of another client. However, in some exemplary embodiments, an agreement may exist between two or more remote clients and, in some of these situations, the sharing of information or resources between the two or more remote clients that are parties to the agreement may take place.

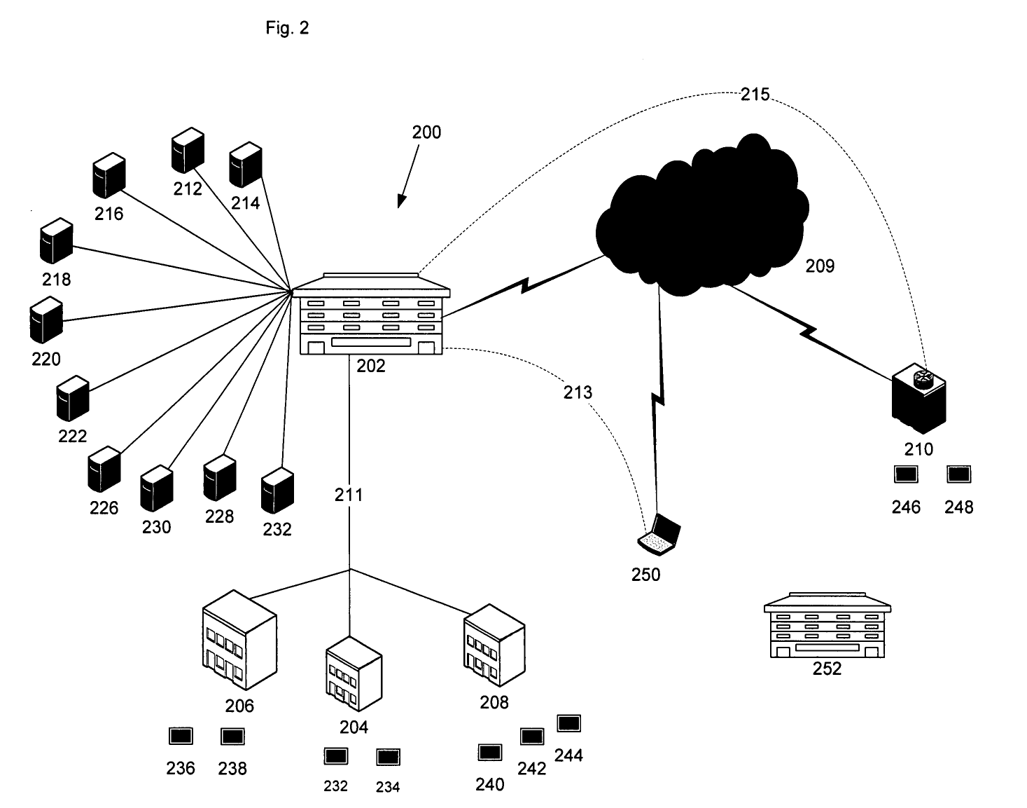

In a further exemplary embodiment, as shown in FIG. 2, a variety of IT services may be administered in different manners. For example, IT support method and system 200 may include a centralized data center 202. Additionally, with IT support method and system 200, any number of clients may utilize the method and system. For example, clients 204 and 210 may be any type of business or any other entity that may utilize IT support or IT services. Clients 204 and 210 may be located any distance from data center 202. Clients 204 and 210 may also be connected to data center 202 in any manner known to one having ordinary skill in the art, for example a connection through an Internet-based portal 209, a direct connection provided 211 by one or more service providers or any other connection, such as one utilizing virtual private network (VPN) 213 or VPN 215. Clients 204 and 210 may also have any number of offices that may utilize IT support method and system 200. For example, as shown in FIG. 2, client 204 may be located in a first office and may include branch offices 206 and 208. Branch offices 206 and 208 may be located physically proximate to client 204 or may be located at any distance from client 204 or data center 202. Additionally, branch offices 206 and 208 may be connected to both client 204, the other branch offices or data center 202 in any manner known to one having ordinary skill in the art.

In a further exemplary embodiment, client 204 or client 210 may receive any of a variety of different services from data center 202. Additionally, data center 202 may house any desired equipment centrally so as to be able to better provide services to any clients, such as client 204 or client 210. For example, either or both of client 204 and client 210 may desire to have websites, email, internet access, internal networks (i.e. intranet), wireless, mobile devices, antivirus and spam protection and/or any other of a variety of services. Therefore, data center 202 may house a variety of equipment to provide access, provide service or provide support. For example, a group of servers, such as domain controller servers 212 and 214, email servers 216 and 218, wireless device servers 220 and 222, antivirus servers 224 and 226 and intranet servers 228 and 230 may be physically located at data center 202. These servers and any other servers or equipment may act to provide service and support for any device or service desired by client 204 or client 210. In further exemplary embodiments, data center 202 may have an individual server or servers that can provide for the service required by one or more clients. In other exemplary embodiments, data center 202 may have individual servers for each individual service and/or for each individual client. Thus, data center 202 may have a first email server 216 specifically for client 204, a second email server specifically for client 210, and so on. Also, in other exemplary embodiments, any of the servers described herein may be virtual servers or utilize virtual server technology, such as VMWare Virtual serving technology or any other virtual server technology.

In a further exemplary embodiment, after a client has chosen the services they wish for data center 202 to provide, data center 202 may provide, administer or support those services remotely. For example, client 204 may be connected to data center 202 using direct connection 211, which may be a T-1 or DS-3 private line. Using that connection, data center 202 may be able to remotely access and manage any computers or other networked devices at location of client 204 in any manner known to one having ordinary skill in the art. For example, an IT support or service employee located at data center 202 could access any computer, for example computers 232 through 244, located at remote client 204 or branch offices 206 and 208 of remote client 204. Additionally, using the above-described connections, client 204 and branch offices 206 and 208 may have access to any IT resources, such as a help desk, knowledge database or any other resource of data center 202.

Further, because data center 202 may provide support to many different types of clients, a client may be connected to data center in any number of different manners. Thus, a connection may be made with client 210, or any other client, that is different from that of client 204. Therefore, as shown in FIG. 2, client 210 may be connected to data center 202 using a standard internet connection 209. The internet connection 209 may be used in conjunction with a demilitarized zone (DMZ), perimeter network, firewall or any other means known to one having ordinary skill in the art so as to allow client 210 proper and secure access to the resources of data center 202 and to allow data center 202 to securely access and perform service on any appropriate IT devices of client 210.

In further exemplary embodiments, virtual private networks may also be utilized. For example, client 210 may have any number of users who may operate outside of the office of client 210. Therefore, in one embodiment, remote user 250 may be employed by client 210. However, remote user 250 may be in a position that requires him or her to travel or otherwise spend time out of the office of client 210. Therefore remote user 250 may have a laptop or notebook computer, or another device, such as a Blackberry® or other wireless communication device. Remote user 250 may connect to the Internet, check their email or access a private network through a standard Internet connection or portal, which may be a wireless connection. Further, in this manner, remote user 250 may be able to access the resources available to client 210 through data center 202. Additionally, in some exemplary embodiments, there may be a need for enhanced security of communications, remote access to a private network or there may be an event where a computer or other wireless communication device is in need of IT support or service. In these situations remote user 250 may utilize VPN 213 so that data center 202, or an employee thereof, may securely access the computer or other wireless device of remote user 250. Similarly, a VPN, such as VPN 215 may be used for any communications with any remote client, for example remote client 210.

In a further exemplary embodiment, data center 202 may include a call center. The call center may act as a help desk, for example providing twenty four hour service and response to questions. Additionally, clients may be able to email IT service or support-related questions to data center 202 and receive a timely response twenty four hours a day. Similarly, IT support and service may be handled via real-time online chatting.

In yet another exemplary embodiment, the data center may be able to coordinate on-site IT support or service. For example, if a client, such as client 204, has a significant IT-related problem, requires a greater degree of service or needs on-site installation or servicing of hardware, a mobile consultant may be dispatched to perform that task. Therefore, as shown in FIG. 2, in the event on-site service is needed, a mobile consultant from a location local to client 204 may be dispatched. The mobile consultant may be an employee who works out of a branch office, e.g. mobile consultant center 252, may be dispatched from data center 202 or may be a consultant or sub-contractor retained by data center 202.

In a further exemplary embodiment, any number of data centers may be located in any number of places. For example, a data center may be located centrally proximate a large metropolitan area. Therefore, the data center could provide IT service and support remotely from clients, allowing the clients to enjoy full-scale IT service and support without having in-house staff or requiring a complete IT infrastructure in-house. Additionally a data center located proximately to a metropolitan area may allow for the dispatching of on-site consultants to perform any on-site IT support or service that may be desired or required by a client.

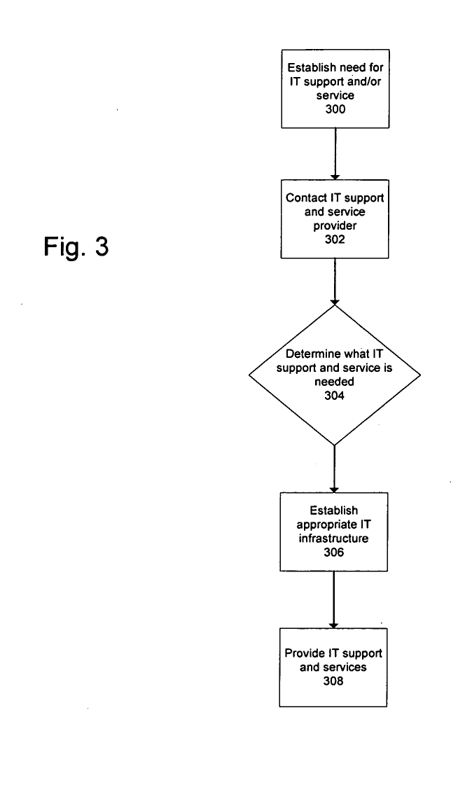

In another embodiment, shown in exemplary FIG. 3, a client may have IT support and service tailored to their specific needs. In a first step, 300 a client may establish that they need IT support, service or both. This may come about as a result of the client being a new company, the client being unable to afford previous IT staff, the client parting ways with previous IT staff or consultants, the client being unwilling or unable to house and support the necessary IT infrastructure or the client adding various IT to their existing company.

Next, in step 302, an IT support and service provider may be contacted by the client. The IT support and service provider may be one that is able to provide a wide variety of IT services as well as provide support for those services as well as other services, software and hardware. In step 304, the IT support and service provider may consult with the client to determine the amount and/or level of IT service and support that the client may need. As described above, the IT services and support can include Internet access, Internet content filtering, designing, administering and maintaining a website, administering and maintaining email, preventing unauthorized access to a client's data, virus and spam protection, design and maintenance of a private network or intranet, time and attendance reporting, financial processing and reporting, data and systems backup and recovery, support of mobile IT devices and any other IT service or support desired or known by one having ordinary skill in the art.

After determining the level and amount of IT service and support desired in step 304, the appropriate IT infrastructure may be established in step 306. This step can include the installation of hardware or software for both the client and the IT support and service provider, the establishment of various data connections between the client and the IT support and service provider and any other infrastructure that may allow an IT support and service provider to properly interact with a client and the appropriate IT devices. Because the service provider will provide most, if not all, of the IT service and support from a remote location, the establishment of the appropriate infrastructure at a client site may be relatively limited. For example, in one embodiment, any number of servers having any amount of data stored thereon may be located at the service provider site. Therefore much of the necessary hardware infrastructure will already exist or may be easily implemented for the client. The client, however, may need the installation or purchase of computers and appropriate data connection ports so that they may access the resources housed at the service provider site. Thus, in this exemplary embodiment, the client may reduce their IT costs because they do not need to purchase and set up hardware such as serves and the necessary infrastructure, such as racks appropriate cooling, to house and maintain the servers. Additionally, in this exemplary embodiment, the client may avoid the costs associated with maintaining an IT staff and infrastructure on their premises.

Finally, in step 308, the IT support and service provider may provide the desired IT support and service to the client. As described herein, the support and service may cover a wide range of functions and may evolve. For example, a client may desire to add or subtract any number of services at any time during their relationship with the IT support and service provider. Additionally, the IT support and service provider may enhance their operations to allow for services not originally contemplated when their relationship with the client began.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for providing information technology service, comprising:
a data center;
at least one client located remotely from the data center and in need information technology service; and
at least one data connection between the data center and the client;
wherein the data center provides information technology service to the client through the use of the data connection.

2. The system of claim 1, wherein the information technology services the at least one client need comprise:
Internet access, Internet content filtering, design and maintenance of a website, email access, virus protection, spam filtering, protection against unauthorized access of data, private network management, financial processing and reporting, hardware support, software support and time and attendance reporting.

3. The system of claim 1, further comprising:
a plurality of servers housed at the data center.

4. The system of claim 3, wherein the plurality of servers housed at the data center each provide a specific information technology service for the at least one client.

5. The system of claim 1, further comprising a mobile consultant dispatched by the data center to the remote client when the client needs on-site information technology service.

6. The system of claim 1, wherein the data connection between the data center and the at least one remote client is a virtual private network.

7. The system of claim 1, wherein the at least one remote client has access to the broad information technology resources of the data center through the data connection.

8. The system of claim 1, wherein the information technology infrastructure for the at least one remote client is located at the data center.

9. The system of claim 1, wherein the data center establishes a uniform information technology policy for the at least one remote client.

10. A method for providing information technology service, comprising:
contacting an information technology service provider;
determining, through a consultation between the information technology service provider and a client,-the amount of information technology service the client needs;
building an infrastructure to provide the amount of information technology service the client needs; AND
providing information technology service to the client by the information technology service provider from a remote location.

11. The method of claim 10, further comprising:
administering the information technology service to the client through a data connection.

12. The method of claim 11, wherein the data connection is an Internet connection.

13. The method of claim 11, wherein the data connection is a direct connection.

14. The method of claim 11, wherein the data connection is through a virtual private network.

15. The method of claim 10, further comprising:
maintaining the information technology infrastructure of the client at the location of the information technology service provider.

16. The method of claim 10, further comprising:
dispatching an information technology consultant from a location of the information technology service provider to a location of the client when the client requires on-site information technology service at the location of the client.

17. The method of claim 10, further comprising:
eliminating the need of the client to maintain an information technology staff.

18. The method of claim 10, wherein the information technology service provider provides twenty four hour information technology service and support to the client.

19. A system for providing information technology-related services to a remotely located client, comprising:
means for connecting a remotely located client to an information technology service provider;
means for securing the connection between the remotely located client and the information technology service provider;
means for the remotely located client to access data stored at the location of the information technology service provider;
means for the information technology service provider to provide information technology service and support to the remotely located client; AND
means for providing on-site information technology service by the information technology service provider to the remotely located client.

20. The system of claim 20, further comprising:
means to eliminate the need of the remotely located client to have information technology staff.
